(19) United States
(12) Patent Application Publication
(10) Pub. No.: US 2014/0337301 A1
(43) Pub. Date: Nov. 13, 2014

(54) BIG DATA EXTRACTION SYSTEM AND METHOD

(71) Applicant: Almondsoft Co., Ltd., Seoul (KR)

(72) Inventors: Jinho Jang, Seoul (KR); Kumhee Hwang, Seoul (KR)

(73) Assignee: ALMONDSOFT CO., LTD., Seoul (KR)

(21) Appl. No.: 14/140,437

(22) Filed: Dec. 24, 2013

(30) Foreign Application Priority Data
May 8, 2013 (KR) 10-2013-0051877

(51) Int. Cl. G06F 7/24; G06F 17/30

(52) U.S. Cl. CPC G06F 7/24; G06F 17/3033
USPC 707/698

(57) ABSTRACT

Disclosed herein are a big data extraction system and method. The big data extraction system includes a data buffer unit for hooking the file message of an operating system, extracting some data from the original data based on the hooked file message, and storing the extracted some data in memory, a data generation unit for generating hash data of the stored some data, verifying the hash data of the stored some data, and generating regeneration data corresponding to the original data based on a result of the verification, and a data storage unit for storing the regeneration data.

### CROSS REFERENCE TO RELATED APPLICATION

This patent document claims the benefit of priority of Korean Patent Application No. 10-2013-0051877, filed in the Korean Intellectual Property Office on May 8, 2013. The entire content of the before-mentioned patent application is incorporated by reference as part of the disclosure of this document.

### BACKGROUND OF THE INVENTION

1. Technical Field

The present invention relates to a big data extraction system and method and, more particularly, to a big data extraction system and method, which are capable of increasing a data input and output (I/O) speed by storing collected data in memory having a relatively higher data I/O speed instead of auxiliary memory having a lower data I/O speed.

More particularly, the present invention relates to a big data extraction system and method which are capable of reducing the waste of the storage space of memory in such a manner that a message regarding the file system of an operating system in which data is stored in auxiliary memory is hooked and stored in the memory and some of the corresponding data is extracted and stored.

2. Description of the Related Art

Recently, as the amount of unit data is increased and quality of data becomes higher, the amount of data to be processed by a computer becomes diverse from megabyte (MB) to terabyte (TB). Accordingly, the memory capacity of memory in which the large amount of data is stored is increased, and many inventions regarding memory for storing the large amount of data are being developed and used.

Korean Patent Laid-Open Publication No. 10-2004-0071693, that is, one of examples of inventions regarding memory for storing the large amount of data, discloses the preservation of snapshots for selected data of a high-capacity memory system. This invention has an advantage in that it can reduce the amount of data necessary for storage by generating a snapshot copy of data for minimum data transmission and storing the snapshot copy.

The conventional invention regarding a high-capacity memory system is problematic in that (i) a data I/O speed is slow because data is stored in auxiliary memory, (ii) altered data cannot be detected although the original data is altered because hash values of the original data and the altered data are not compared with each other, and (iii) a data search speed is fast, but data needs to be dually stored because both the original data and data extracted from the original data must be stored.

In order to solve the problems of the conventional invention regarding a high-capacity memory system, the inventors of the present invention have contrived a big data extraction system and method which are capable of reducing the waste of the storage space of memory in such a manner that a message regarding the file system of an operating system in which data is stored in auxiliary memory is hooked and stored in memory and some of the corresponding data is extracted and stored.

### PRIOR ART DOCUMENT

### Patent Document

(Patent Document 1) Korean Patent Laid-Open Publication No. 10-2004-0071693

### SUMMARY OF THE INVENTION

The present invention has been made keeping in mind the above problems occurring in the prior art, and an object of the present invention is to provide a big data extraction system and method, which are capable of increasing a data I/O speed by storing collected data in memory having a relatively higher data I/O speed instead of auxiliary memory having a lower data I/O speed.

Another object of the present invention is to provide a big data extraction system and method in which data is stored in memory having a relatively higher speed not in auxiliary memory having a relatively lower speed by hooking a message regarding the file system of an operating system.

Yet another object of the present invention is to provide a big data extraction system and method which are capable of minimizing the amount of data stored in memory by extracting some data from the original data based on a message regarding a hooked file system.

Further yet another object of the present invention is to provide a big data extraction system and method which are capable of checking whether or not some data is identical with the original data by comparing hash data of some data with hash data of the original data.

Still yet another object of the present invention is to provide a big data extraction system and method which are capable of regenerating data corresponding to the original data using one or more some data.

Still yet another object of the present invention is to provide a big data extraction system and method which are capable of verifying stability and also storing data in memory.

In accordance with an aspect of the present invention, a big data extraction system includes a data buffer unit for hooking the file message of an operating system, extracting some data from original data based on the hooked file message, and storing the extracted some data in memory, a data generation unit for generating hash data of the stored some data, verifying the hash data of the stored some data, and generating regeneration data corresponding to the original data based on a result of the verification, and a data storage unit for storing the regeneration data.

Preferably, the data buffer unit may include a hooking module for hooking the file message, an extraction module for extracting the some data from the original data based on the file message, and a transmission module for transmitting the extracted some data to the data generation unit in real time.

Preferably, the hooking module may process the hooked file message so that the data buffer unit is capable of processing the hooked file message.

Preferably, the extraction module may extract metadata regarding the original data.

Preferably, the data generation unit may include a hash data generation module for generating the hash data of the some data received from the data buffer unit, a hash data determination module for determining whether or not the hash data of the some data is identical with original hash data of the original data, a regeneration data generation module for generating the regeneration data including one or more some data stored in the memory, and a regeneration data check module for checking an error of the regeneration data.

Preferably, the hash data determination module may detect an error of the some data based on a result of the determination.

Preferably, the regeneration data check module may check the integrity and redundancy of each piece of the one or more regeneration data.

In accordance with another aspect of the present invention, a big data extraction method includes hooking the file message of an operating method, extracting some data from original data based on the hooked file message, and storing the extracted some data in memory, generating hash data of the stored some data, verifying the hash data of the stored some data, and generating regeneration data corresponding to the original data based on a result of the verification, and storing the regeneration data.

Preferably, the extracting of the some data from the original data based on the hooked file message and the storing of the extracted some data in the memory may include hooking the file message, extracting the some data from the original data based on the file message, and transmitting the extracted some data to the data generation unit in real time.

Preferably, the hooking of the file message may include changing the hooked file message.

Preferably, the extracting of the some may include extracting metadata regarding the original data.

Preferably, the generating of the hash data of the stored some data may include generating the hash data of the some data received from the data buffer unit, determining whether or not the hash data of the some data is identical with original hash data of the original data, generating the regeneration data including one or more some data stored in the memory, and checking an error of the regeneration data.

Preferably, the determining of whether or not the hash data of the some data is identical with the original hash data of the original data may include detecting an error of the some data based on a result of the determination.

Preferably, the checking of the error of the regeneration data may include checking integrity and redundancy of each piece of the one or more regeneration data.

### BRIEF DESCRIPTION OF THE DRAWINGS

FIG. 1 is a diagram showing the overall operation of a big data extraction system in accordance with an embodiment of the present invention;

FIG. 2 is a block diagram showing the construction of the big data extraction system in accordance with an embodiment of the present invention;

FIG. 3 is a block diagram of a data buffer unit shown in FIG. 2;

FIG. 4 is a block diagram of a data generation unit shown in FIG. 2; and

FIG. 5 is a detailed flowchart illustrating the operation of the big data extraction system in accordance with an embodiment of the present invention.

### DETAILED DESCRIPTION

Hereinafter, a data conversion apparatus and method in accordance with some embodiments of the present invention are described with reference to the accompanying drawings. The thickness of lines and the size of elements shown in the drawings may have been enlarged for the clarity of a description and for convenience′ sake. Furthermore, terms to be described later are defined by taking the functions of embodiments of the present invention into consideration, and may be different according to the operator's intention or usage. Accordingly, the terms should be defined based on the overall contents of the specification.

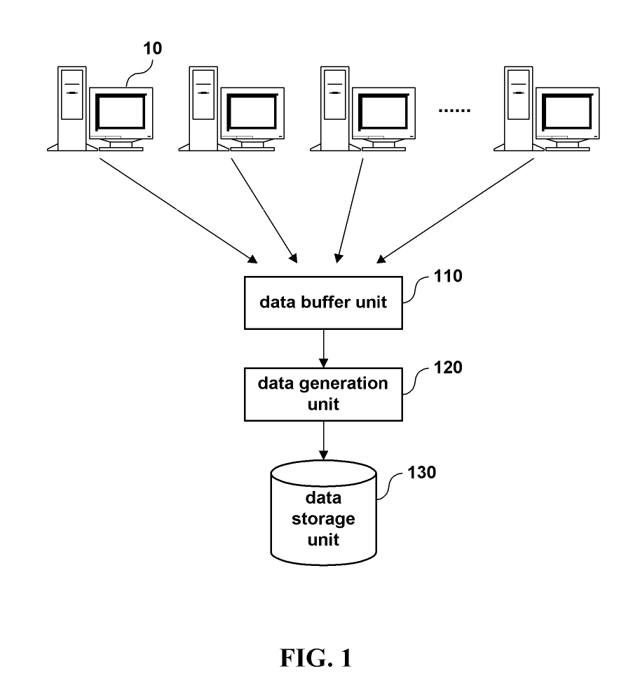

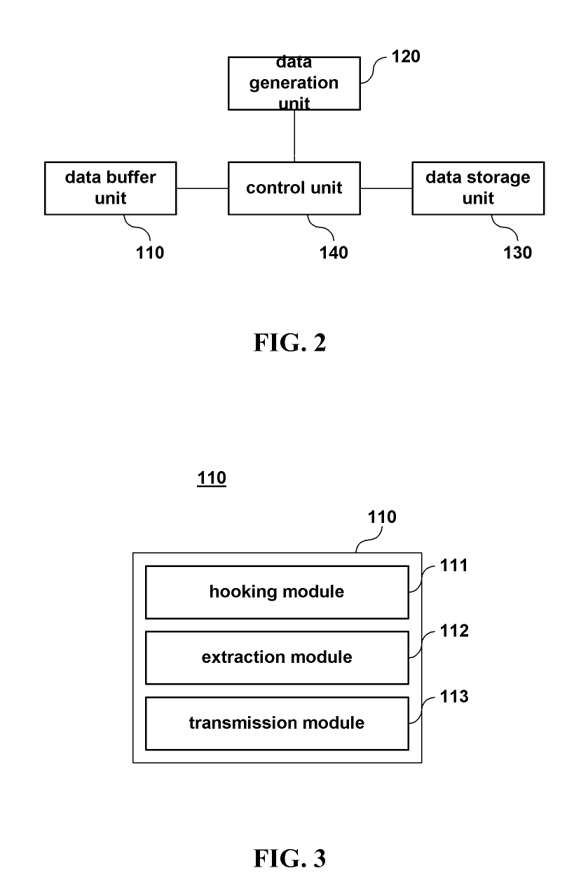

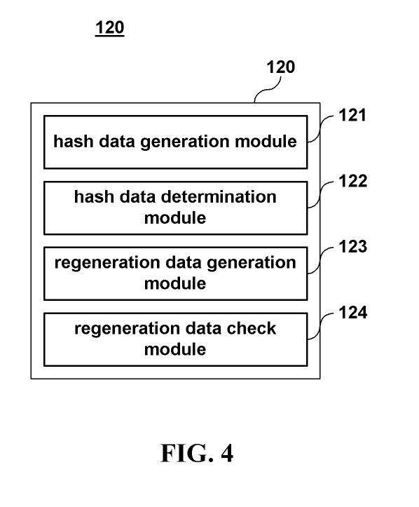

FIG. 1 is a diagram showing the overall operation of a big data extraction system in accordance with an embodiment of the present invention, FIG. 2 is a block diagram showing the construction of the big data extraction system in accordance with an embodiment of the present invention, FIG. 3 is a block diagram of a data buffer unit shown in FIG. 2, and FIG. 4 is a block diagram of a data generation unit shown in FIG. 2.

Referring to FIGS. 1 to 4, the big data extraction system 100 includes a data buffer unit 110, a data generation unit 120, a data storage unit 130, and a control unit 140.

First, the data buffer unit 110 can perform a function of hooking messages regarding the file systems of operating systems within one or more computers 10, extracting some data from the original data based on the messages, and storing the extracted data in memory.

The message regarding the file system within the computer 10 (hereinafter called a ‘file message’) may mean a message for naming various types of data necessary for an operating system that drives the computer 10 and configuring the storage locations or storage paths of the data for storage or search purposes.

To this end, the data buffer unit 110 may include a hooking module 111, an extraction module 112, and a transmission module 113.

The hooking module 111 can perform a function of fetching a command regarding storage that is included in a file message so that memory not auxiliary memory becomes a location at which data is stored.

The auxiliary memory may mean a recording medium on which data can be recorded and from which data can be deleted, of a hard disk (HDD), a USB, a floppy disk, and a NAND drive. Furthermore, the memory may mean a temporary storage place where data moved from auxiliary memory can be executed. The memory may have a much higher data I/O speed than the auxiliary memory.

Furthermore, the hooking module 111 can perform a function of processing a hooked file message so that the data buffer unit 110 can process the hooked file message.

The term ‘hooking’ may mean a technique for intercepting a password, a message, or events generated from an operating system. This technique is already known in the art, and a detailed description thereof is omitted. Data of the computer 10 can be stored in memory not in auxiliary memory irrespective of the file storage command of an operating system by means of the hooking module 111.

The extraction module 112 can perform a function of extracting some data from the original data stored in the computer 10 based on a file message hooked by the hooking module 111.

The term ‘original data’ may mean all types of data that may be processed by the computer 10. The original data may mean data prior to processing which has not been altered or lost.

The terms ‘some data’ may mean processed data whose amount has been reduced to the extent that a loss of data is minimized based on the original data. For example, the distance between areas displayed on a map, the distance between roads, and the distance between buildings may correspond to the original data because they need base data regarding the distance and size. A coordinate value of a building which has been represented by digitizing data, indicating that the building is spaced apart from a specific building by a specific distance in a specific direction, in a vector form, may correspond to some data.

Such some data having a vector form may have an advantage in that the waste of the storage capacity of memory can be minimized because only a digitized distance value has only to be stored as compared with the original data having a scalar form. It is however to be noted that the type and size of some data are not limited as long as some data contains essential information to be represented in the original data.

Furthermore, the extraction module 112 can perform a function of extracting metadata regarding the original data.

The term ‘metadata’ may correspond to attribute information about the original data and also mean data regarding attributes, such as a writer, a purpose, storage, and a storage place that are necessary to manage the original data. Meanwhile, the metadata is already known in the art, and a detailed description thereof is omitted.

The transmission module 113 can perform a function of sending some data to the data generation unit 120. The transmission module 113 can send some data stored in memory in real time.

A method of sending, by the transmission module 113, some data may include both wireless and wired methods. In the case of wired communication, the method may correspond to a communication method using a copper line cable, a coaxial cable, and an optical fiber cable. In the case of wireless communication, the method may correspond to WiBro, High Speed Downlink Packet Access (HSDPA), Wi-Fi, ZigBee, and Bluetooth.

The file message of the operating system is midway hooked and processed by the data buffer unit 110 as described above. The big data extraction system 100 can extract some data from the original data based on the processed file message and send the extracted some data to the data generation unit 120 in real time.

The data generation unit 120 can perform a function of generating hash data regarding some data received from the data buffer unit 110, verifying the generated hash data, and generating regeneration data corresponding to the original data based on a result of the verification.

To this end, the data generation unit 120 may include a hash data generation module 121, a hash data determination module 122, a regeneration data generation module 123, and a regeneration data check module 124.

First, the hash data generation module 121 can perform a function of generating hash data regarding some data received from the data buffer unit 110.

The term ‘hash data’ may mean data for determining whether or not some data is identical with the original data. For example, assuming that the original data has an encrypted text arrangement, the text arrangement may also be changed if the original data is altered or information about the original data is changed. If a text arrangement of hash data of some data extracted from the original data has been changed, the corresponding some data may be determined to be not data corresponding to the original data or to be data whose information has been altered or lost.

Accordingly, the hash data generated by the hash data generation module 121 may be used as means for determining whether or not some data is identical with the original data, whether or not some data has been altered, whether or not information about some data has been altered, and whether or not some data has been lost.

It is however to be noted that the hash data is not limited to a specific construction as long as the hash data can be used to determine whether or not information about some data has been altered, whether or not some data has been lost, and whether some data is authentic or not.

The hash data determination module 122 can perform a function of determining whether or not the original data is identical with some data, whether or not information about the original data or some data has been altered, and whether or not the original data or some data has been lost based on the hash data generated by the hash data generation module 121. Furthermore, the hash data determination module 122 can perform a function of detecting an error of some data. Meanwhile, the functions of the hash data determination module 122 have been described about in connection with the hash data generation module 121, and a detailed description thereof is omitted.

The regeneration data generation module 123 can perform a function of generating regeneration data corresponding to the original data using one or more some data that are present in memory in fragments.

The term ‘regeneration data’ may mean data restored to include information to be represented by the original data using some data that has been verified to be authentic and that has been verified to be not altered and lost using the aforementioned hash data. The regeneration data may have the same amount as or a smaller amount than the original data.

As a result, corresponding information can be used through the regeneration data generated by the regeneration data generation module 123, even without fetching the original data of the computer 10.

The regeneration data check module 124 can perform a function of checking an error of the regeneration data generated by the regeneration data generation module 123.

The regeneration data check module 124 may check the integrity and redundancy of the regeneration data and compare the regeneration data with the original data in order to check the accuracy of information once more.

The data storage unit 130 can perform a function of storing regeneration data whose integrity and redundancy have been checked by the regeneration data check module 124. The data storage unit 130 may correspond to memory having a higher data I/O speed than a hard disk (HDD) or auxiliary memory or may correspond to a Solid State Drive (SSD) which is similar to a hard disk, but has a much higher data I/O speed than the hard disk.

It is however to be noted that memory used in the data storage unit 130 is not limited to a specific type and size as long as the data storage unit 130 corresponds to memory which stores verified regeneration data and has a much higher data I/O speed than existing auxiliary memory.

The control unit 140 can perform a function of controlling the flow of data of the data buffer unit 110, the data generation unit 120, and the data storage unit 130.

The elements and functions of the big data extraction system 100 have been described so far, but the operation of the big data extraction system 100 is described in more detail below.

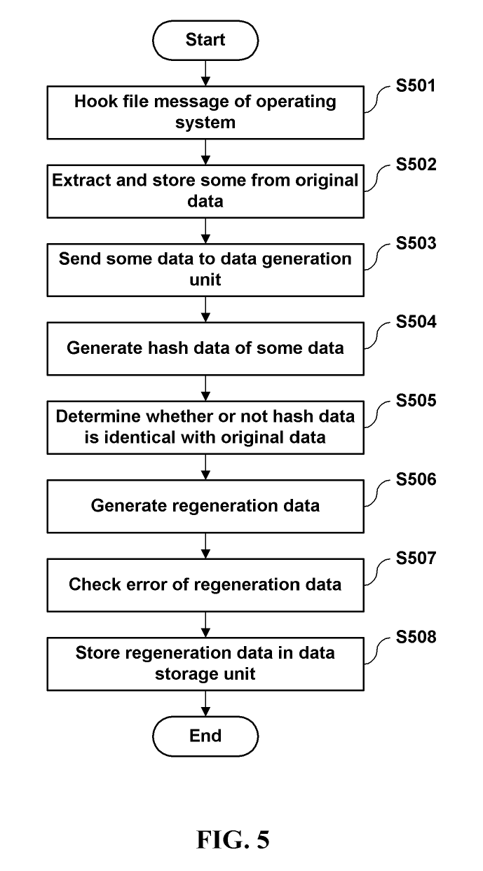

FIG. 5 is a detailed flowchart illustrating the operation of the big data extraction system 100 in accordance with an embodiment of the present invention.

Referring to FIG. 5, the big data extraction system 100 first hooks the file message of an operating system within the computer 10 at step S501 and stores data in memory not in auxiliary memory based on the hooked file message.

Next, the big data extraction system 100 extracts some data, including the most fundamental information, from the original data and temporarily stores the extracted some data in the memory at step S502.

Simultaneously with the storage of the extracted some data, the transmission module 113 sends the some data to the data generation unit 120 in real time at step S503, and the hash data generation module 121 generates hash data of the some data at step S504.

Next, the hash data determination module 122 determines whether or not information about the some data has been altered or whether or not some data has been lost by comparing hash data of the some data with hash data of the original data at step S505.

Next, the regeneration data generation module 123 generates regeneration data corresponding to the original data using some data whose determination has been completed at step S506, and at the same time, the regeneration data check module 124 checks the integrity, redundancy, and an error of the regeneration data at step S507.

After the regeneration data is checked, the data storage unit 130 stores the checked regeneration data at step S508.

As described above, the big data extraction system and method have an advantage in that they can reduce the storage space of memory because the file message of the computer 10 is hooked, data is stored in response to the hooked file message, some data is extracted from the original data, and the extracted data is stored. Furthermore, there is an advantage in that the safety of stored information can be primarily checked by generating hash data of some data and determining the generated hash data and the safety of the information can be secondarily checked by generating regeneration data using the some data and checking an error of the generated regeneration data.

The big data extraction system and method in accordance with an embodiment of the present invention have an advantage in that they can increase a data I/O speed by hooking a message regarding the file system of an operating system and storing the large amount of data in memory having a higher data I/O speed.

Furthermore, the big data extraction system and method have advantages in that they can minimize the amount of data stored in memory, increase the amount of data stored, and also minimize the waste of the storage capacity of memory because some data is extracted from the original data based on a hooked file message.

Furthermore, the big data extraction system and method have an advantage in that they can determine whether or not some data is identical with the original data and whether or not some data has been altered by comparing hash data of the some data with hash data of the original data.

Furthermore, the big data extraction system and method have an advantage in that they can precisely represent information to be represented by the original data although the original data is not additionally fetched because data corresponding to the original data is regenerated using one or more some data.

Furthermore, the big data extraction system and method have an advantage in that they can check whether or not data has been lost or altered by checking the integrity and redundancy of regenerated data.

Although some exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A big data extraction system, comprising:
a data buffer unit for hooking a file message of an operating system, extracting some data from original data based on the hooked file message, and storing the extracted some data in memory;
a data generation unit for generating hash data of the stored some data, verifying the hash data of the stored some data, and generating regeneration data corresponding to the original data based on a result of the verification; and
a data storage unit for storing the regeneration data.

2. The big data extraction system of claim 1, wherein the data buffer unit comprises:
a hooking module for hooking the file message;
an extraction module for extracting the some data from the original data based on the file message; and
a transmission module for transmitting the extracted some data to the data generation unit in real time.

3. The big data extraction system of claim 2, wherein the hooking module processes the hooked file message so that the data buffer unit is capable of processing the hooked file message.

4. The big data extraction system of claim 2, wherein the extraction module extracts metadata regarding the original data.

5. The big data extraction system of claim 1, wherein the data generation unit comprises:
a hash data generation module for generating the hash data of the some data received from the data buffer unit;
a hash data determination module for determining whether or not the hash data of the some data is identical with original hash data of the original data;
a regeneration data generation module for generating the regeneration data comprising one or more some data stored in the memory; and
a regeneration data check module for checking an error of the regeneration data.

6. The big data extraction system of claim 5, wherein the hash data determination module detects an error of the some data based on a result of the determination.

7. The big data extraction system of claim 5, wherein the regeneration data check module checks integrity and redundancy of each piece of the one or more regeneration data.

8. A big data extraction method, comprising:
hooking a file message of an operating method, extracting some data from original data based on the hooked file message, and storing the extracted some data in memory;
generating hash data of the stored some data, verifying the hash data of the stored some data, and generating regeneration data corresponding to the original data based on a result of the verification; and
storing the regeneration data.

9. The big data extraction method of claim 8, wherein the extracting of the some data from the original data based on the hooked file message and the storing of the extracted some data in the memory comprises:
hooking the file message;
extracting the some data from the original data based on the file message; and
transmitting the extracted some data to the data generation unit in real time.

10. The big data extraction method of claim 9, wherein the hooking of the file message comprises changing the hooked file message.

11. The big data extraction method of claim 9, wherein the extracting of the some comprises extracting metadata regarding the original data.

12. The big data extraction method of claim 8, wherein the generating of the hash data of the stored some data comprises:
generating the hash data of the some data received from the data buffer unit;
determining whether or not the hash data of the some data is identical with original hash data of the original data;
generating the regeneration data comprising one or more some data stored in the memory; and
checking an error of the regeneration data.

13. The big data extraction method of claim 12, wherein the determining of whether or not the hash data of the some data is identical with the original hash data of the original data comprises detecting an error of the some data based on a result of the determination.

14. The big data extraction method of claim 12, wherein the checking of the error of the regeneration data comprises checking integrity and redundancy of each piece of the one or more regeneration data.
